(19) United States
(12) Patent Application Publication
(10) Pub. No.: US 2006/0274701 A1
(43) Pub. Date: Dec. 7, 2006

(54) Means and method for notification

(75) Inventor: Henrik Albertsson, Stockholm (SE)

Correspondence Address: NIXON & VANDERHYE, PC, 901 NORTH GLEBE ROAD, 11TH FLOOR, ARLINGTON, VA, 22203, US

(73) Assignee: Telefonaktiebolaget LM Ericsson (publ), Stockholm (SE)

(21) Appl. No.: 11/143,931

(22) Filed: Jun. 3, 2005

(51) Int. Cl. H04Q 7/24

(52) U.S. Cl. 370/338; 370/401

(57) ABSTRACT

A method for notification in packet-switched communication networks is provided. An application server (40) that wants to notify a mobile terminal (42) transmits a notification message intended for this mobile terminal. The notification is forwarded to a notification server (45), typically via control logic (44). If the status of the mobile terminal corresponds to a first predefined status, for example “non-available”, the notification (41) is stored at the notification server until it receives an indication of a status change to a second predefined status, for example “available”. In response to the status change, the notification is transmitted from the notification server to the mobile terminal, typically via the control logic.

### TECHNICAL FIELD

The present invention relates to packet-switched communication systems and in particular to notification of mobile terminals in such systems.

### BACKGROUND

In packet-switched networks of today, and in particular mobile IP networks and IP multimedia systems, there are a number of situations where the system needs to notify applications in individual mobile terminals in order to trigger services in the terminals. Typical cases when a notification is sent include those when a new message has been received and when someone wishes to initiate communication with the mobile terminal. Notifications of this kind may be, but are generally not, displayed to the end user.

The normal way to achieve IP connectivity and peer-to-peer connections is to introduce an overlay network, such as the IP Multimedia Subsystem (IMS) [1]. IMS provides IP services independent of applications and platforms. IMS uses the Session Initiation Protocol (SIP) [2] as session control mechanism. SIP is indifferent to media and defines how a connection should be handled irrespective of whether the content is voice, video, data or web-based. By means of SIP, mobile devices can be registered and peer-to-peer connections initiated.

When there is IP connectivity to the mobile terminal, notifications can normally be sent in a straightforward and non-problematic manner. However, often the recipient cannot be reached, e.g. when the device is out of coverage, switched off, etc., making the notification issue far from trivial.

Traditional telecom services handle this by pushing out an SMS message and the SMSC will hold the notification until the recipient becomes available.

MMS is an example of this. Such a store-and-forward mechanism is not very well suited for use in connection with IP multimedia systems, such as IMS. It relies on outdated and unnecessarily complex technology and is associated with drawbacks, such as uncertainties relating to the delivery time and restrictions on the form and content of messages.

The International Patent Application [3] uses a store and forward mechanism for IMS systems based on the same principles as the mentioned SMS notification. The leads to a comparatively complicated and non-efficient notification solution.

Accordingly, there is a need for an improved notification mechanism for packet-switched communication and in particular for a notification mechanism suitable for use in IP multimedia systems.

### SUMMARY

A general object of the present invention is to provide an improved method for notification in packet-switched communication systems. A specific object is to achieve improved notification in IP multimedia systems. Another object is to provide a notification mechanism associated with efficient handling of resources. Still another object is to provide a notification mechanism that is easy to implement.

These objects are achieved in accordance with the attached claims.

Briefly, the present invention proposes a new kind of store-and-forward mechanism, in which a notification server on the recipient side of the communication is used to handle notifications based on the status of the mobile terminal addressed by the notification. If it is determined that the recipient is not available, for example, the notification is stored at the notification server until the recipient becomes available. When the mobile terminal becomes available, the notification server receives an indication of this and attempts to deliver the notification message to the mobile terminal.

The status of the mobile terminal can relate to the IP connectivity thereof, such as “available”/“non-available”. There may also be embodiments in which the status relates to the geographic position of the mobile terminal.

The present invention may be implemented in an IP multimedia system, such as IMS. It enables the system to have services that are delivered to offline users when they becomes available, which is a considerable advantage. The notification server may then for example be implemented as a SIP Application Server (SIP AS) and the notification message may be SIP-based, e.g. using SIP NOTIFY or SIP MESSAGE.

In accordance with different aspects of the invention, a method for notification, a notification server, and a packet-switched communication system with means for notification are provided.

### BRIEF DESCRIPTION OF THE DRAWINGS

The invention, together with further objects and advantages thereof, may best be understood by making reference to the following description taken together with the accompanying drawings, in which:

FIG. 1 is a schematic overview of an exemplary network for IP multimedia communication in which the present invention can be implemented;

FIG. 2 is a schematic block diagram illustrating a conventional notification mechanism using SMS messages;

FIG. 3 is a schematic block diagram illustrating another conventional notification mechanism;

FIG. 4 is a schematic block diagram illustrating a notification mechanism in accordance with an example embodiment of the present invention;

FIG. 5 is a schematic block diagram illustrating a notification mechanism in accordance with another example embodiment of the present invention;

FIG. 6 is a schematic block diagram illustrating a notification mechanism in accordance with still another example embodiment of the present invention;

FIG. 7 is a schematic block diagram illustrating a notification server in accordance with an example embodiment of the present invention; and

FIG. 8 is a flow chart of a notification method according to an exemplary embodiment of the present invention.

### DETAILED DESCRIPTION

A list of abbreviations follows at the end of this section.

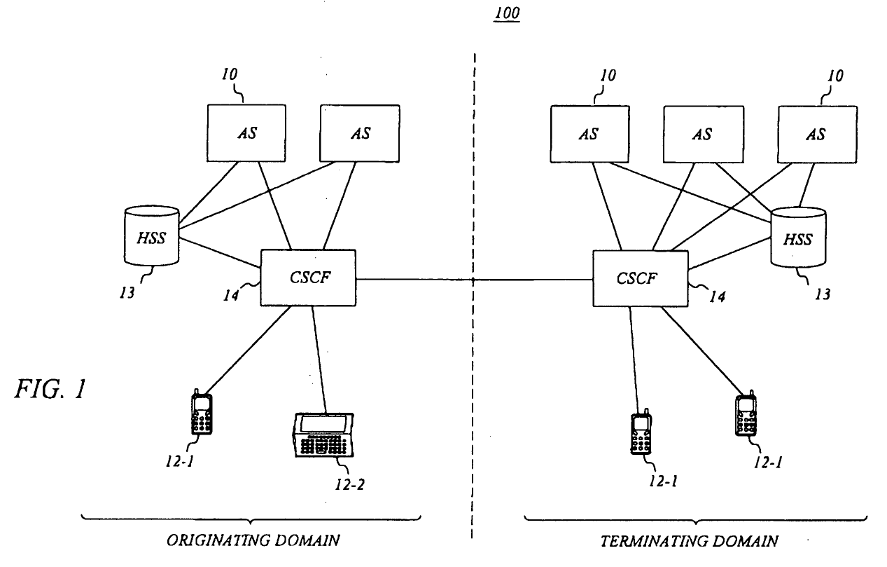

FIG. 1 is a schematic overview of an exemplary network for IP multimedia communication in which the present invention can be implemented. This network is built according to the IMS architecture but it is to be understood that the present invention is not limited to IMS but may very well be used in connection with other IP multimedia systems or still other packet-switched systems.

IMS defines a horizontal layered network architecture. The illustrated system 100 comprises application functionality with application and content servers 10, executing various services for the end user. The services may for example be implemented in SIP application servers (SIP AS). The IMS system further comprises control functionality, i.e. network control servers for managing call or session set-up, modification and release, the most important of which is CSCF 14. The CSCF 14, also known as SIP server, manages SIP sessions and coordinates with other network elements for session control, feature/service control and resource allocation. For this, the CSCF 14 is arranged to communicate with the application servers 10 as well as with mobile terminals 12 and a HHS 13 in the domain. The HHS 13 holds IMS subscriber profiles and among other things comprises functionality for authentication and authorization as well as functionality for supporting CSCF and AS access. The application servers 10 may interact with the HSS 13 to obtain subscriber profile information. As for the mobile terminals 12, here exemplified as mobile phones 12-1 and a laptop 12-2, IMS services require that they are equipped with IMS/SIP clients. Such clients typically include a GUI, service logic, routing and discovery functionality, etc.

Still referring to FIG. 1, assume that a mobile terminal 12 of the originating domain wants to send a message to a mobile terminal of the terminating domain. The message is sent from the terminal 12 via the CSCF 14 at the originating domain, where triggers downloaded from a HSS 13 may trigger originating services in a messaging application server 10, such as messaging size controllers and virus filters. From the originating CSCF 14, the message is delivered to the terminating CSCF 14, where terminating services may be invoked in a messaging application server 10 based on triggers downloaded from a HSS 13. Such services may for example be block lists. The message is then routed via the terminating CSCF 14 towards the recipient terminal 12. For the message to be delivered, the recipient terminal 12 needs to be connected and available.

In IMS, the preferred signalling is SIP. SIP does not explicit have the notion of storing notifications for later delivery as it is intended as a protocol for handling “live” sessions. Nevertheless, it would be most desirable to have a store-and-forward (deferred) notification delivery mechanism in IMS/SIP and similar environments.

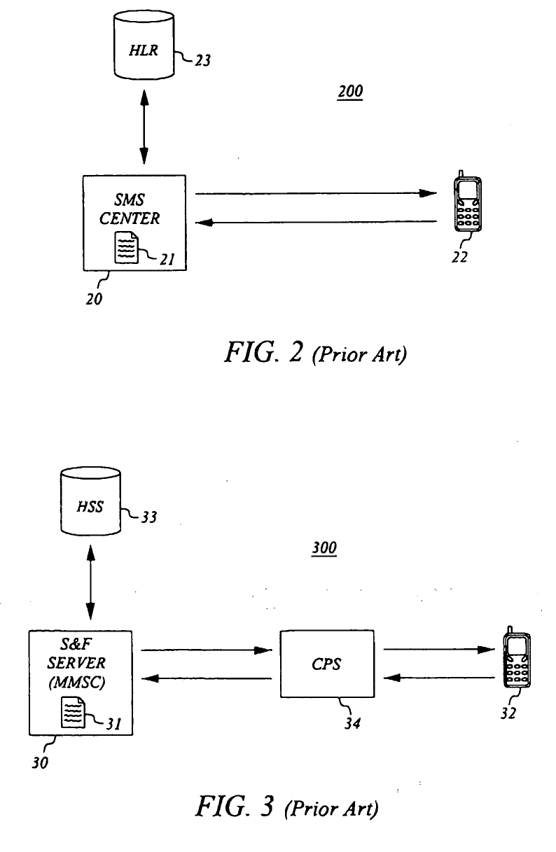

Conventional store-and-forward of notifications in the mobile domain normally uses SMS messages. FIG. 2 is a schematic block diagram illustrating such a prior-art notification mechanism. Assume, for example, that a MMS message is to be sent to a mobile terminal 22 of a communication system 200, e.g. from another mobile terminal or from a server. The mobile terminal 22 will be notified of the new MMS via a SMS bearer. This SMS notification 21 is provisioned using SMSC 20 that acts as a store-and-forward mechanism for short messages. The SMSC 20 uses the network operator's HLR 23 to locate the mobile terminal 22 in the network. If the HLR 23 responds to the SMSC 20 with the subscriber status “inactive”, the SMSC 20 will hold on to the message for a period of time. When the subscriber accesses his device 22, the HLR 23 becomes aware of this and informs the SMSC 20, which delivers the SMS notification 21. The actual MMS message is stored in a MMSC in the home domain and can be collected by the mobile terminal 22 based on the information in the SMS notification 21.

As mentioned in the background section, store-and-forward by SMS is not very well suited for use in connection with IP multimedia systems, such as IMS. Another conventional notification mechanism is illustrated in FIG. 3, which is a schematic block diagram based on the solution presented in the International Patent Application [3]. [3] provides functionality that enables MMSC to interface with mobile multimedia architecture e.g. IMS. In accordance therewith, SIP messages include a signaling flag that for example indicates whether the message is to be stored and forwarded. [3] also mentions usage of SIP messages for MMS reception notification as an evolution of the SMS bearer. Such a store and forward mechanism is adapted for IMS systems but directly corresponding to the above-described SMS notification. In the system 300 of FIG. 3, a Store and Forward (S&F) server 30, such as a modified MMSC (or an application server in combination with an MMSC), provides functionality corresponding to the one of the SMSC of FIG. 2. It carries out the appropriate storage function as indicated by the flag. The notification 31 is stored at the S&F server 30 until the mobile terminal 32 becomes available and the status of the mobile terminal 32 is monitored by a HHS 33 arranged to communicate with the S&F server 30. HSS 33 alerts the S&F server 30 when the terminal 32 is reachable for sending the notification 31 to fetch the stored MMS message. The communication between the S&F server 30 and the mobile terminal 32 goes via a call processing server (CPS) 34 in the network, comprising a CSCF.

Although the solution of FIG. 3 provides for store-and-forward of notification messages in an IMS/SIP environment, it is still associated with the disadvantages of the SMS solution of being complex and demanding. In particular, with such a solution, functionality for handling notifications will be implemented in each of the respective application servers/MMSCs. This means that there will be a lot of the same functionality in the different application servers. Moreover, the CSCF will be loaded with many parallel 3^{rd} party registrations.

In order to overcome the described disadvantages of solutions like the one in FIG. 3, the present invention proposes a new kind of store-and-forward mechanism, in which a notification server on the recipient side of the communication is used to handle notifications based on the status of the mobile terminal addressed by the notification. If it is determined that the recipient is not available, for example, the notification is stored at the notification server until the recipient becomes available.

The status of the mobile terminal is preferably related to the IP connectivity thereof, such as “available”/“non-available”. There may also be embodiments in which the status instead (or in addition) is related to the geographic position of the mobile terminal. The status change can in such a case for example occur when the mobile terminal enters a specified geographic region.

The proposed terminal notification will now be further explained with reference to some example embodiments.

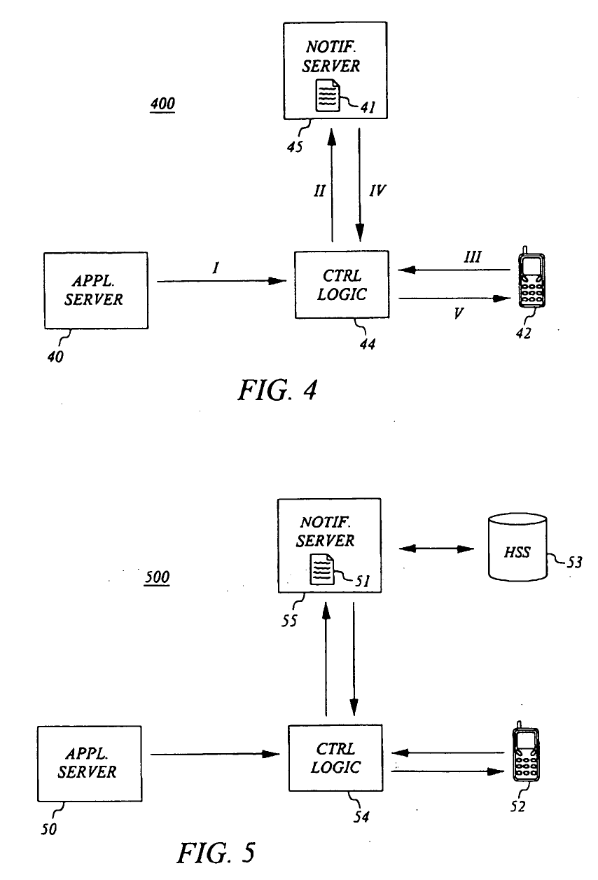

FIG. 4 is a schematic block diagram of a notification mechanism in accordance with an example embodiment of the present invention. A service, represented by application server 40, needs to notify a recipient, represented by mobile terminal 42 based for example on a SIP message, such as SIP NOTIFY. The notification is transmitted from the application server to control logic 44 in the network 400 (I). The control logic 44 recognizes that the notification cannot be sent to the recipient, and forwards it to a notification server 45, where the notification 41 is stored for deferred delivery (II). The determining, by the control logic 44, of the status of the mobile terminal 42 can for instance use a trigger for “Not Registered”, since the mobile terminal 42 normally needs to register with the control logic 44 for establishing IP connectivity (III). As the status of the recipient 42 changes, in this example to “available”, the control logic 44 becomes aware of this, for example through a 3^{rd} party registration procedure. The notification 41 is fetched from the storage at the notification server 45 (IV), and sent to the recipient 42 (V), enabling the service logics to be executed at the recipient 42.

The present invention may with advantage be implemented in an IP multimedia system, such as IMS. In IMS terms, the application server 40 can then e.g. comprise or correspond to a presence server, a messaging server, and/or a location server. The control logic would typically be a CSCF, preferably with “not registered triggers” routing SIP notifications to the notification server. The notification server, in turn, could then be implemented as a SIP application server specially adapted for handling notifications from a variety of services to many different recipients. Finally, the recipient would in an IMS system typically be a mobile terminal with a client for Presence or Messaging, for example.

By means of the present invention, IMS and other IP multimedia/SIP based networks will be able to have services that are delivered to offline users when they become available. The inefficient SMS based notification mechanism is reduced to a more intelligent and resource efficient handling of IP based notifications using the notification server of the present invention. This enables development of new services and improves the service behavior.

With conventional solutions like the one illustrated in FIG. 3, there will be a lot of the same functionality in the different application servers and the CSCF (or corresponding node) will be loaded with many parallel 3^{rd} party registrations. The present invention offers a more elegant solution, in which a notification server handles the notification of many different services in a centralized manner. In this way, the individual application servers do not have to be concerned with the notification message after transmitting it and therefore experience less load in this respect.

The application server can for example use the notification message to notify the mobile terminal of the fact that a message, e.g. an MMS, for the mobile terminal has been received. Alternatively, the notification message can indicate that one mobile terminal wants to initiate communication with another mobile terminal.

Other embodiments may relate to a type of service that constantly sends notifications to the terminal regarding changes in parameters related to location and presence. For example, envision a location service that sends out location coordinates of a moving vehicle to a map application in a mobile terminal. The client in the terminal takes the coordinates and draws a line on the map to illustrate how the vehicle moves. It is easily understood that the performance of the service will be poor if some of the locations updates are lost, in which case the line is likely to be incorrect. The safe notification delivery of the present invention considerably increases the performance and value of such a service.

The notification message can with advantage be SIP based, for example comprising or being based on SIP NOTIFY or SIP MESSAGE. However, it should be emphasized that the invention is not restricted to SIP communication but can be used in connection with other notifications as well.

The information related to the status of the mobile terminal can be provided in different ways in different embodiments of the invention. The storing of the notification message can be preceded by a non-successful attempt of sending the notification message to the mobile terminal. In such a case, the transmission failure indirectly indicates the status of the mobile terminal to the notification server.

The storing of the notification message may also be preceded by a storage decision based on knowledge of the current status of the mobile terminal. Such knowledge is typically provided to the notification server from an external unit. In case the mobile terminal registers with a session control function, such as the CSCF, this unit could for example communicate information regarding the connectivity of the mobile terminal to the notification server. FIG. 4 relates to such a solution. An application server with more advanced logics can also be used instead of or complementary to CSCF. In one particular embodiment, illustrated in FIG. 5, the notification server 55 interacts with a HSS 53 to obtain information related to the status of the mobile terminal 52. The notification server 55 then uses information regarding e.g. the connectivity of the mobile terminal 52 contained in the subscriber profile of the HSS 53 to determine how the notification message 51 is to be handled. Alternatively, the status of the mobile terminal 52 is communicated to the notification server 55 by means of a presence or location server (not shown), that monitors the position of the mobile terminal 52 more or less continuously. (The AS 50 and control logic 54 of the system 500 correspond to those of FIG. 4.)

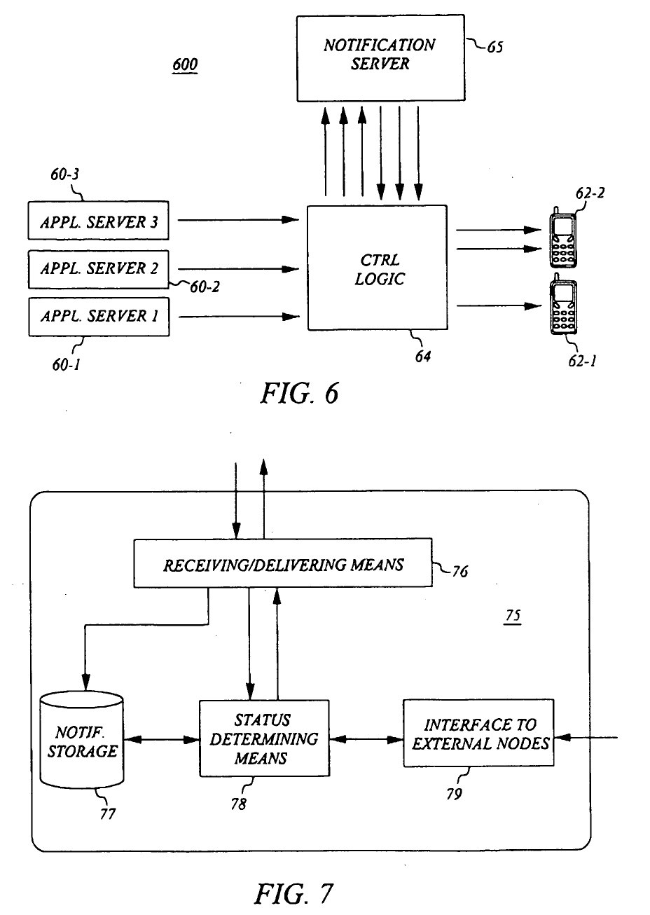

FIG. 6 is a schematic block diagram illustrating a notification mechanism in accordance with still another example embodiment of the present invention. The notification server 65 of FIG. 6 is capable of handling notifications from a number of application servers 60-1, 60-2, 60-3 at the same time. The notifications are transmitted to the notification server 65 for storage via control logics 64 in the network 600. As the status of the respective terminals 62-1, 62-2 changes, the notification server 65 forwards the notifications to the appropriate terminal(s) 62-1, 62-2. In the example of FIG. 6, there are two terminals, one of which is the recipient of two notification messages but variants are of course possible. There may for instance be cases where one application server transmits a plurality of notification messages for one or more mobile terminals.

It should be noted that by means of the present invention, in cases where the notification is used to notify the terminal of a message such as a MMS, only the notifications are stored at notification server. The actual messages are contained at the originating application server or elsewhere depending on the application. Moreover, the sender of the notification, i.e. the application server, will not be involved in initiating retransmission since this is handled by the notification server. No functionality for store and forward of notifications need to be included in the respective application servers. Hence, the proposed notification mechanism is associated with the further advantage of being easy to implement.

FIG. 7 is a schematic block diagram illustrating the logical elements of a notification server in accordance with an example embodiment of the present invention. The simplified notification server 75 of FIG. 7 comprises means 76 for receiving and delivering notifications, notification storage means 77, means 78 for determining the status of mobile terminals, and an interface 79 to external nodes. Upon receiving a notification message via the receiving means 76, the status determining means 78 typically determines whether the status of the mobile terminal is such that the notification can be sent or not. This involves some interactions between the status determining means 78 and external nodes, such as CSCF, HSS, presence servers etc, via the interface 79. (Alternatively, the status is determined based on the outcome of a transmission attempt.) In case the notification cannot be sent, it is transferred to the storage 77. The status determining means 78 interacts with the external node(s) to know when the status of the mobile terminal changes. The status information may be provided to the notification server continuously or upon request. When the notification server 75 knows that there has been a certain kind of status change, the notification is fetched from the storage 77 and delivered (or at least sent out for delivery) by the notification delivering means 76.

Furthermore, the notification server 75 may be provided with means (not shown) for deciding which notification messages that are to be stored at the notification storage 77 until the recipient is available. The storage decision may for example be based on the identity of the originator/sender or on the type of notification message. There may also be embodiments where the notification message contains a time stamp, defining a “time-to-live” for the notification, and the storage is performed accordingly.

A notification server according to the present invention can for example be implemented as or comprise a SIP AS arranged at the terminating domain of the communication system. It is typically adapted for simultaneously handling notification messages from a plurality of application servers, as illustrated in FIG. 6. Nevertheless, there may of course be more than one notification server present in the same terminating network.

According to a particular embodiment, the notifications to the recipient are aggregated in order to prevent the recipient from being not flooded by many notification messages when the status changes. A plurality of notification messages for the mobile terminal are in such a case aggregated in a suitable manner, e.g. into one SIP message, whereby the aggregated notification messages are sent together to the mobile terminal in response to the status change (e.g. when the recipient becomes available). The means for aggregating notification messages is preferably provided at the notification server, but may also be implemented elsewhere in the network, for instance at the CSCF.

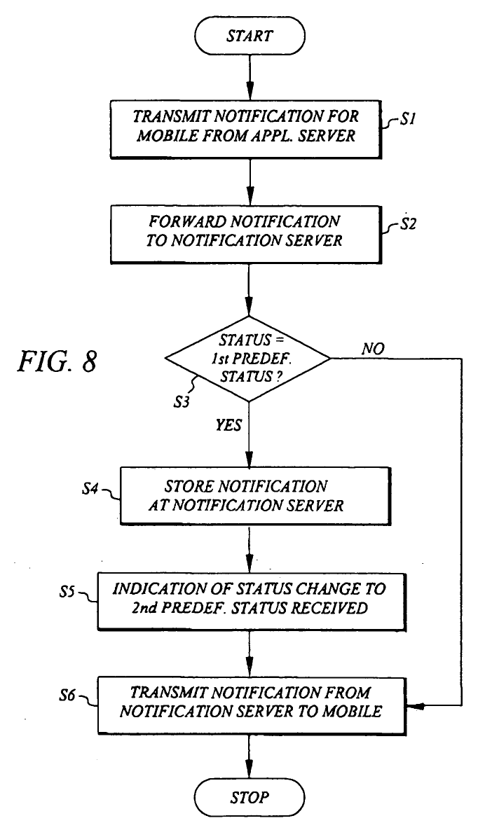

FIG. 8 is a flow chart summarizing a notification method according to an exemplary embodiment of the present invention. In a first step S1, an application server that wants to notify a mobile terminal transmits a notification message intended for this mobile terminal. The notification is forwarded to a notification server (step S2), typically via control logics such as a CSCF. Step S3 checks the status of the mobile terminal. If the status of the mobile terminal corresponds to a first predefined status, for example “non-available”, the notification is stored at the notification server (step S4) until it receives an indication of a status change to a second predefined status, for example “available” (step S5). The status change may e.g. result from registration of the mobile terminal in the communication system. In response to the status change, the notification is transmitted from the notification server to the mobile terminal in a final step S6. Normally, this communication occurs via the CSCF or similar control logics. In case the status of the mobile terminal does not require the notification to be stored, for example if the mobile terminal is already available, the procedure would normally go directly from step S3 to step S6 as indicated by the arrow in FIG. 8.

Although the invention has been described with reference to specific illustrated embodiments, it should be emphasized that it also covers equivalents to the disclosed features, as well as modifications and variants obvious to a man skilled in the art. Thus, the scope of the invention is only limited by the enclosed claims.

### ABBREVIATIONS

AS—Application Server
CPS—Call Processing Server
CSCF—Call Service Control Function
GUI—Graphical User Interface
HLR—Home Location Register
HSS—Home Subscriber Server
IMS—IP Multimedia Subsystem
IP—Internet Protocol
MMS—Multimedia Messaging Service
MMSC—Multimedia Messaging Service Center
S&F—Store & Forward
SIP—Session Initiation Protocol
SMS—Short Message Service
SMSC—Short Message Service Center

### REFERENCES

[1] 3GPP TS 23.228 V6.9.0 (2005-03).
[2] SIP: Session Initiation Protocol, RFC 3261, June 2002.
[3] The International Patent Application WO 03/087972 A2, Nokia Inc., published Oct. 23, 2003.

1. A method for notification in a packet-switched communication system including an application server and a mobile terminal, comprising the steps of:
transmitting a notification message for the mobile terminal from the application server;
forwarding the notification message to a notification server in the communication system and storing the notification message at the notification server if the mobile terminal is associated with a first predefined status;
receiving, at the notification server, an indication of a status change at the mobile terminal from the first predefined status to a second predefined status; and
transmitting the notification message from the notification server to the mobile terminal in response to the indication of the status change.

2. The method of claim 1, wherein the first predefined status and the second predefined status of the mobile terminal are related to the IP connectivity thereof.

3. The method of claim 2, wherein the status change is associated with the step of registering the mobile terminal in the communication system.

4. The method of claim 1, wherein the storing of the notification message is preceded by a non-successful attempt of sending the notification message to the mobile terminal.

5. The method of claim 1, wherein the storing of the notification message is preceded by a storage decision based on knowledge of the current status of the mobile terminal.

6. The method of claim 1, wherein the indication of the status change received at the notification server originates from a communication unit selected from the group of: a Call Session Control Function (CSCF), a Home Subscriber Server (HHS), a location server, and a presence server.

7. The method of claim 1, further comprising the step of determining whether to store the notification message based on the type of message or the identity of the sender.

8. The method of claim 1, further comprising the steps of:
aggregating a plurality of notification messages for the mobile terminal; and
sending the aggregated notification messages together to the mobile terminal in response to the status change.

9. The method of claim 1, wherein the notification message is based on the Session Initiation Protocol (SIP).

10. The method of claim 1, wherein the notification server comprises a SIP application server arranged at the terminating domain of the communication system.

11. The method of claim 1, wherein the packet-switched communication system comprises an IP Multimedia Subsystem (IMS) network.

12. A notification server with means for notification in a packet-switched communication system including an application server and a mobile terminal, comprising:
means for receiving a notification message originating from the application server and being intended for the mobile terminal;
means for storing the notification message if the mobile terminal is associated with a first predefined status;
means for receiving an indication of a status change at the mobile terminal from the first predefined status to a second predefined status; and
means for transmitting the notification message to the mobile terminal in response to the indication of the status change.

13. The notification server of claim 12, wherein the first predefined status and the second predefined status of the mobile terminal are related to the IP connectivity thereof.

14. The notification server of claim 13, wherein the status change is associated with registration of the mobile terminal in the communication system.

15. The notification server of claim 12, wherein the means for storing the notification message is adapted for storing the notification message in response to a non-successful attempt of sending the notification message to the mobile terminal.

16. The notification server of claim 12, comprising means for deciding whether to store the notification message based on knowledge of the current status of the mobile terminal.

17. The notification server of claim 12, arranged to receive the indication of the status change from a communication unit selected from the group of: a Call Session Control Function (CSCF), a Home Subscriber Server (HHS), a location server, and a presence server.

18. The notilication server of claim 12, further comprising means for determining whether to store the notification message based on the type of message or the identity of the sender.

19. The notification server of claim 12, further comprising:
means for aggregating a plurality of notification messages for the mobile terminal; and
means for sending the aggregated notification messages together to the mobile terminal in response to the status change.

20. The notification server of claim 12, adapted for handling notification messages based on the Session Initiation Protocol (SIP).

21. The notification server of claim 12, comprising a SIP application server arranged at the terminating domain of the communication system.

22. A packet-switched communication system with means for notification comprising the notification server; of claim 12.

23. The communication system of claim 22, being an IP Multimedia Subsystem (IMS) network.
